(19) United States
(12) Patent Application Publication
(10) Pub. No.: US 2007/0051084 A1
(43) Pub. Date: Mar. 8, 2007

(54) Collector unit for soil and lawn debris

(75) Inventor: James Carpenter Whitney, Norwalk, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Woodland Power Products, Inc.

(21) Appl. No.: 11/209,924

(22) Filed: Aug. 23, 2005

(51) Int. Cl. A01D 43/06

(52) U.S. Cl. 56/202

(57) ABSTRACT

A collector unit for soil and lawn debris is provided. The collector unit includes a collector frame and a collector bag, which has fabric walls and is supported by the collector frame. The collector frame has a front end and a back end, where the back end is wider than the front end.

### BACKGROUND OF THE INVENTION

1. Field of the Invention

The present disclosure is related to systems and methods for collecting soil and lawn debris. More particularly, the present disclosure is related to a soft-walled tapered collector unit for soil and lawn debris.

2. Description of Related Art

Vacuum collection, mulching, and transportation devices for material such as soil and lawn debris such as, but not limited to, leaves, sticks, rocks, lawn trimmings, and the like (hereinafter “debris”) have been developed. In use, the devices collect the debris in a collector unit or bagger (hereinafter “collector unit”).

Many collector units have hard or rigid (hereinafter “rigid”) walls. The rigid wall collector units are typically made of steel and/or heavy gauge polymers, which increases the weight of the collector unit. Thus, movement of the rigid wall collector units by both a lawn tractor or by hand during storage can be difficult. Further, the rigid wall collector units typically require a large storage, as the rigid walls remain in place after use.

Accordingly, there is a continuing desire for soft-walled collector units for collecting soil and lawn debris.

### BRIEF SUMMARY OF THE INVENTION

It is an object of the present disclosure to provide a soft walled collection unit having a tapered back end.

It is another object to provide a tapered collection unit that can be collapsed for easy storage.

In one embodiment, a collector unit for soil and lawn debris is provided. The collector unit includes a collector frame and a collector bag supported by the collector frame. The collector frame has a front end and a back end, where the back end is wider than the front end. The collector bag has fabric walls.

A collector unit for soil and lawn debris having a collector base, a first side tube, a second side tube, and a collector bag is also provided. The collector base has a front end, a back end, a first side, and a second side. The first side tube is hingedly secured to the first side for rotation about a first axis, while the second side tube is hingedly secured to the second side for rotation about a second axis. The first and second axes are not parallel to one another. The collector bag has fabric walls and is supported by the collector base and the first and second side tubes.

A collector unit for soil and lawn debris having a collector base, a first side tube, a second side tube, a collector bag, and a pair of strut-linkages is also provided. The collector base has a front end, a back end, a first side, and a second side. The first side tube is hingedly secured to the first side for rotation about a first axis, while the second side tube is hingedly secured to the second side for rotation about a second axis. The collector bag has fabric walls and is supported by the collector base and the first and second side tubes. The collector bag is movable between an upright position and a storage position upon rotation of the first and second side tubes. The first and second strut-linkages move in a plane that is parallel to the back end, but the first and second axes are not perpendicular to the plane.

The above-described and other features and advantages of the present disclosure will be appreciated and understood by those skilled in the art from the following detailed description and drawings.

### BRIEF DESCRIPTION OF THE SEVERAL VIEWS OF THE DRAWINGS

FIG. 1 is a side view of a prior art vacuum device;

FIG. 2 is a side view of the prior art vacuum device in a dumping position;

FIG. 3 is a top schematic view of the prior art vacuum device of FIG. 1;

FIG. 4 is a top schematic view of the prior art vacuum device of FIG. 2;

FIG. 5 is a partially exploded top front perspective view of an exemplary embodiment of a tapered soft-wall collector unit according to the present disclosure;

FIG. 6 is a sectional view of the collector unit of FIG. 5, taken along lines 6-6;

FIG. 7 is a top rear perspective view of the collector unit of FIG. 5, in a folded or storage position; and

FIG. 8 is a view of the collector unit of FIG. 6 illustrating the axes of rotation.

### DETAILED DESCRIPTION OF THE INVENTION

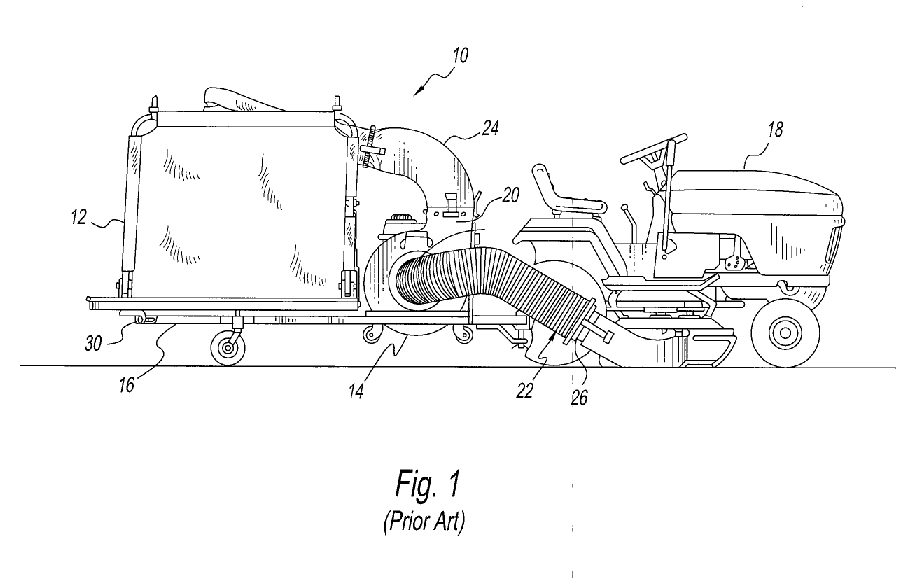

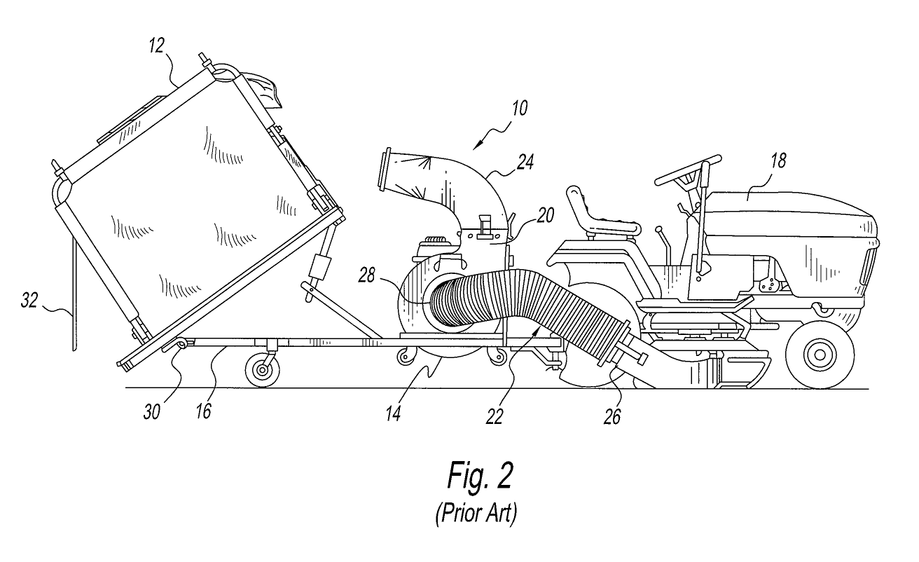

Referring to the drawings and in particular to FIGS. 1 and 2, a prior art vacuum device 10 for use in the collection, mulching, and transportation of debris is shown. Vacuum device 10 can be any known device such as that as shown and described in commonly owned and assigned U.S. Pat. No. 6,029,312, the contents of which are incorporated by reference herein.

Generally, vacuum device 10 includes a debris collector unit 12 and a vacuum generator 14. Collector unit 12 and vacuum generator 14 are mounted on a chassis 16, which is securable to a typical lawn tractor 18. Vacuum generator 14 includes a power plant, such as a gas or diesel engine, for rotating an impeller (not shown) in a housing 20. The rotation of the impeller generates a vacuum in housing 20 and allows the impeller to mulch debris passing through the housing.

Vacuum device 10 includes an intake conduit 22 and an exhaust conduit 24. Intake conduit 22 has a first end 26 and a second end 28. First end 26 is releasably secured to the mower deck of tractor 18, while second end 28 is releasably secured to housing 20. In this manner, intake conduit 22 places vacuum generator 14 in fluid communication with the mower deck of tractor 18. Exhaust conduit 24 is in fluid communication with collector unit 12 so that debris drawn-in and mulched by vacuum generator 14 is collected in the collector unit.

During use, debris and trimmings collected and/or generated by tractor 18 are urged into intake conduit 22 at first end 26 by the power of the tractors mower deck. In addition, vacuum generator 14 pulls a vacuum on the mower deck to pull the debris into vacuum device 10 for mulching and collection in collector unit 12. Once full, debris is removed from collector unit 12 for disposal.

In some instances, the debris can be removed from collector unit 12 and placed into a separate waste container for collection by local and/or state refuse services.

In other instances, collector unit 12 can pivot on chassis 16 via a hinge 30. For example, a panel at the back end 32 of collector unit 12 can be opened and exhaust conduit 24 disconnected from collector unit 12. Next, collector unit 12 can be pivoted to a dumping position 34 as shown in FIG. 2, allowing debris in the collector unit to empty through back end 32 of the collector unit.

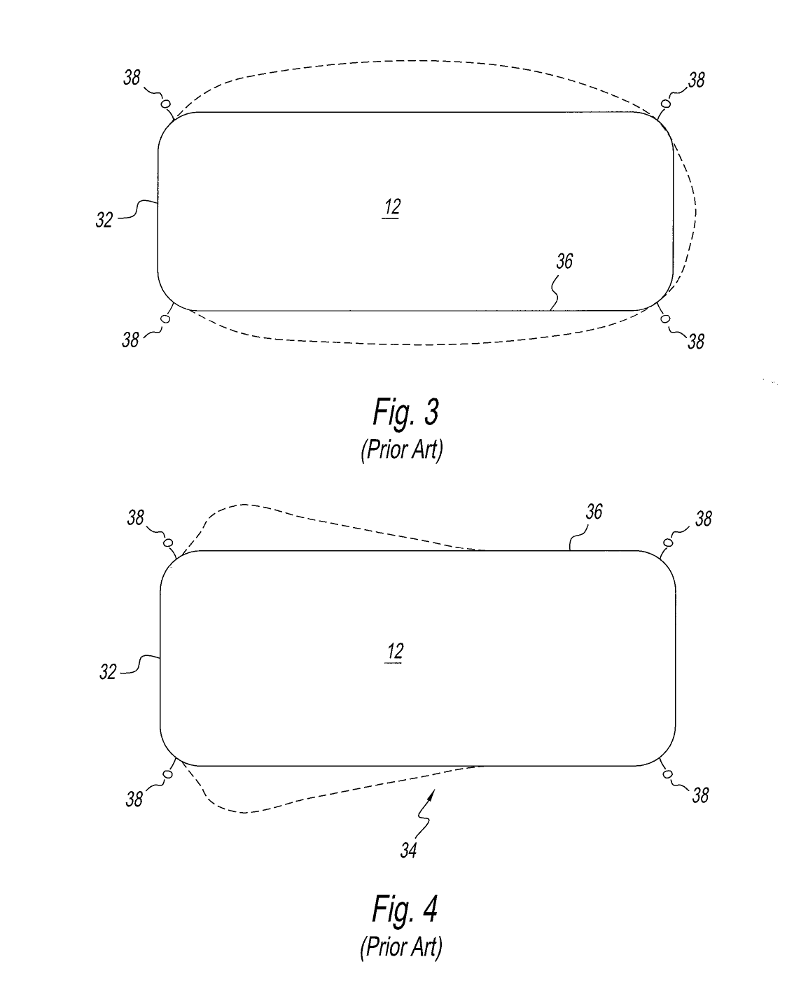

As shown and described in commonly owned and assigned U.S. Pat. No. 6,029,312, collector unit 12 has soft-walls and can be folded for easy storage. However, it has been determined that the soft-walled nature of foldable collector unit 12 may increase the difficulty of dumping debris from the collector unit. Specifically and referring to FIGS. 3 and 4, collector unit 12 has a generally rectangular shape.

Collector unit 12 includes a collector bag having a plurality of fabric walls 36 supported by a collector frame having side tubes 38. In the use position of FIG. 1, fabric walls 36 tend to flex or bow outwards beyond side tubes 38 under the weight of the debris as shown in phantom in FIG. 3.

Since walls 36 are flexed beyond side tubes 38 at back end 32, the side tubes can restrict the flow of debris from collector unit 12 as when moved to dumping position 34. In addition, the weight of the debris within collector unit 12 transfers back towards back end 32 upon moving the collector unit to dumping position 34 as shown in phantom in FIG. 4. The transfer of weight within collector unit 12 further outwardly bows fabric walls 36 beyond side tubes 38 at back end 32, which can increase the restriction of flow from the collector unit.

It has been determined that any container unit having flexible or rigid rectangular walls can experience the aforementioned restriction of flow through the back end of the collector unit. Without intending to be restricted to any particular theory, it is believed that nature of the finely mulched or granular debris material in the collector unit is packed by the natural movement and vibration of the collector unit. The packing of the debris makes the dumping of the debris from rectangular collector units difficult by restricting the flow through the rear end. Accordingly, it has been determined that the usefulness of such rectangular collector units, when in dumping position 34, is less than optimal.

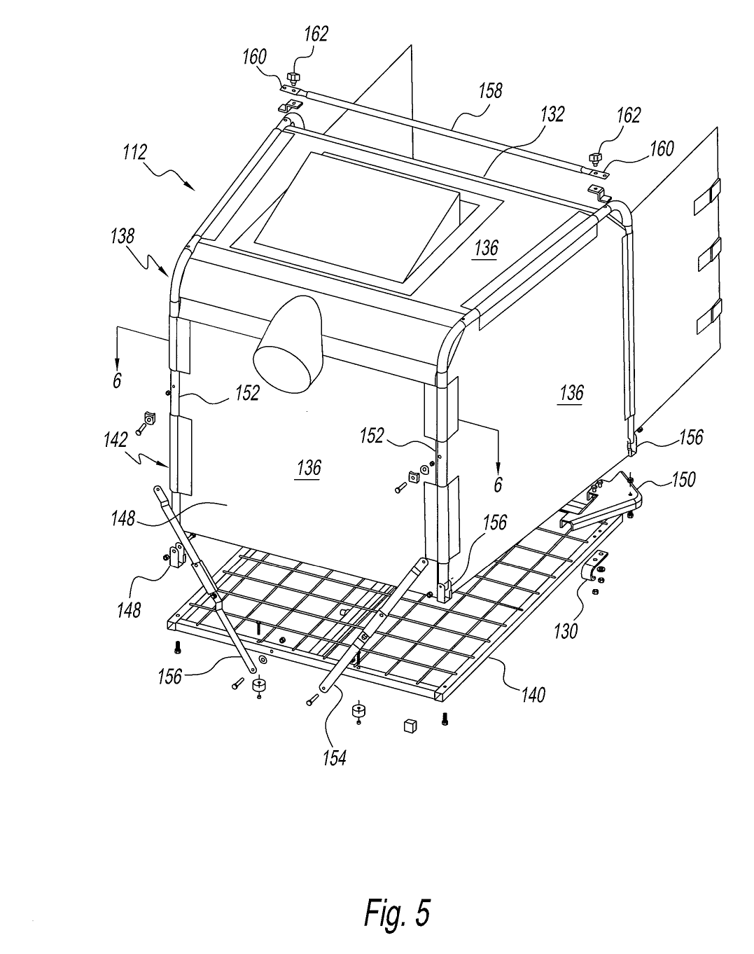

Referring now to FIGS. 5 through 8, an exemplary embodiment of a collector unit according to the present disclosure is shown generally referred to by reference numeral 112. Advantageously, collector unit 112 resolves or mitigates the restriction of flow of debris through back end 132.

Collector unit 112 includes a collector frame 138 having side tubes 152 and a collector base 140, which support a collector bag 142 having fabric walls 136. Collector base 140 can be connected to chassis 16 by hinge 130 for pivoting movement about the hinge to the dumping position.

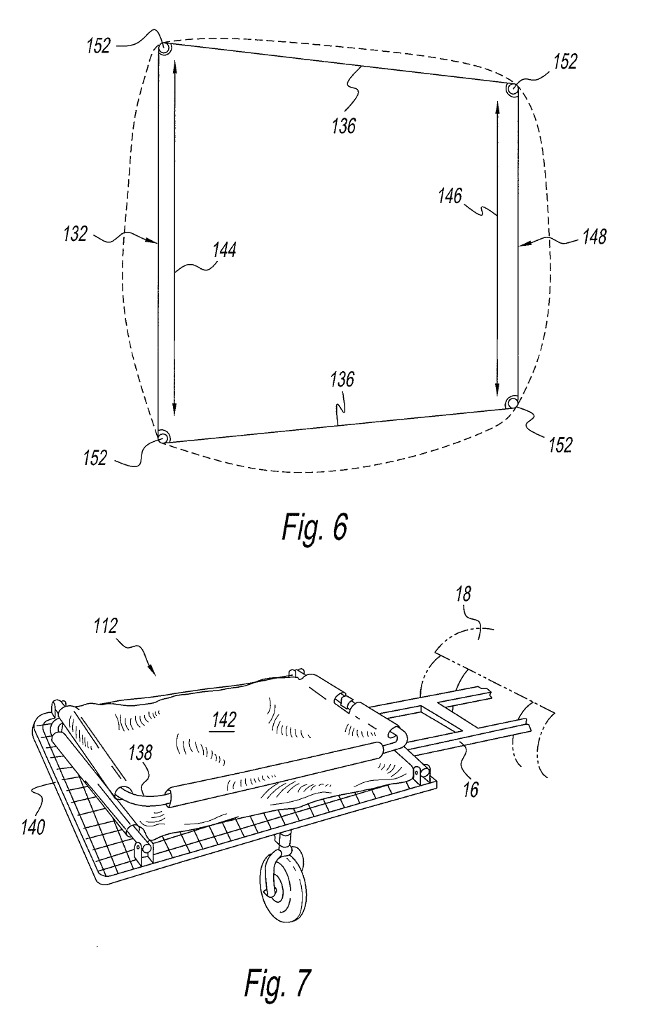

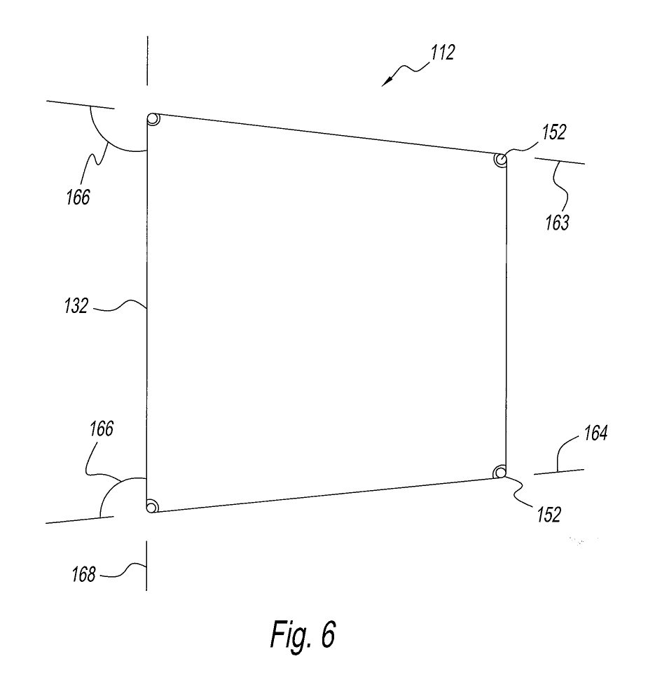

Collector unit 112 has a first width 144 at back end 132 and a second width 146 at a front end 148. First width 144 is larger than second width 146, which provides collector unit 112 with a generally isosceles trapezoidal shape best seen in FIG. 6. First width 144 is larger than second width 146 by at least about 2 inches, more preferably by about 8 inches, with up to about 10 inches being most preferred.

It has been determined having first width 144 wider than second width 146 allows unrestricted flow of debris through back end 132, particularly when collector unit 112 is in the dumping position. In use, fabric walls 136 also tend to flex or bow outwards beyond side tubes 152 under the weight of the debris as shown in phantom in FIG. 6. Since collector unit 112 has first width 144 at back end 132, the wider opening at the back end minimizes and/or eliminates the restriction of flow of the debris through the selectively openable back doors.

In some embodiments, the generally isosceles trapezoidal shape can be provided by securing pair of extender brackets 150 (only one shown) to a collector base 140, which has a generally rectangular shape as shown in FIG. 5. Advantageously, extender brackets 150 allow simply modification of an existing collector unit 12 into collector unit 112. Modification can be provided via a simple modification kit, which includes extender brackets 150 and collection bag 142 for extending the width of the back end 132.

Alternately, collector base 140 itself can be provided with first and second widths 144, 146 to provide the generally isosceles trapezoidal shape as shown in FIG. 7.

The lower free ends of side tubes 152 are secured to hinge brackets 156. Hinge brackets 156 are secured to collector base 140. Thus, hinge brackets 156 allow for movement of side tubes 152 between an upright position (FIG. 5) and a storage position (FIG. 7).

Side tubes 152 can be held in the upright position by a pair of collapsible strut-linkages 154. One end of each strut-linkage 154 is connected to collector base 140, while the other end of each strut-linkage is connected to side tubes 152.

In some embodiments, collector frame 138 can include a transverse bar 158, having its ends 160 removably attached to side tubes 152. A threaded knob 162 can be used to removably attach transverse bar 158 to side tubes 152. The transverse bar 158 can provide additional bracing to hold collector frame 138 in the upright position, but and can be removed to move collector unit 112 to the storage position. In addition, transverse bar 158 can be used to support one or more tools while collector unit 112 is in use.

When it is desired to move side tubes 152 to the storage position, transverse bar 158, if provided, can be removed and collapsible strut-linkages 154 can be activated, one at a time, to permit the side tubes to rotate about hinge brackets 156 toward collector base 140.

Unfortunately, it has been determined that the isosceles trapezoidal shape of collector unit 112 can make movement between the upright position and the storage position difficult. Advantageously, collector unit 112 allows for movement between the upright position and the storage position in a simple and easy manner.

The movement of collector unit 112 is described with reference to FIG. 8. Side tube 152 on one side of collector unit 112 is rotated about a first axis of rotation 162, while the side tube 152 on the opposite side of collector unit 112 is rotated about a second axis of rotation 164. Here, first and second axes 162, 162 are not parallel to one another. Preferably, first and second axes 162, 162 each have an angle 166 with respect to back end 132 of up to about 100 degrees, more preferably up to about 96 degrees. Strut-linkages 154, due to their connection with collector base 140 and side tubes 152, want to move in a plane 168 that is parallel to back end 132 of collector unit 112. As such, first and second axes 162, 162 are not perpendicular to plane 168. Unfortunately, this awkward arrangement of axes and planes can make movement between the upright position and the storage position difficult.

It has been determined by the present disclosure that additional freedom in the movement about first and second axes 162, 164 and plane 168 can be introduced in a surprisingly simple and efficient manner to allow for the desired movement.

In some embodiments, the clearance of the fit between tubes 152, struts 154, and hinges 156 can provide sufficient freedom of movement to allow movement between the upright position and the storage position. In other embodiments, flexion in tubes 152, struts 154, and hinges 156, within the elastic region of these components, can provide sufficient freedom of movement to allow movement between the upright position and the storage position. In still other embodiments, a combination of clearance and flexion can be used to provide sufficient freedom of movement to allow movement between the upright position and the storage position.

In this manner, the isosceles trapezoidal shape of collector unit 112, which makes movement between the upright position and the storage position difficult, can be overcome to allow the collection unit to be folded while minimizing and/or eliminating the restriction of flow of the debris through the selectively openable back doors when in the dumping position.

It should also be noted that the terms “first,” “second,” “third,” “upper,” “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the present disclosure.

1. A collector unit for soil and lawn debris, comprising:
a collector frame defining a front end and a back end, said back end being wider than said front end;
a collector bag having fabric walls, said collector bag being supported by said collector frame; and
a hinge for securing said collector frame to a chassis so that said collector frame is moveable about said hinge to move between a use position and a dumping position.

2. (canceled)

3. The collector unit as in claim 1, wherein said back end is wider than said front end by at least about 2 inches.

4. The collector unit as in claim 1, wherein said back end is wider than said front end by about 8 inches.

5. The collector unit as in claim 1, wherein said collector frame and said collector bag are moveable between an upright position and a storage position.

6. A collector unit for soil and lawn debris, comprising:
a collector base having a front end, a back end, a first side, and a second side;
a first side tube hingedly secured to said first side for rotation about a first axis;
a second side tube hingedly secured to said second side for rotation about a second axis; and
a collector bag having fabric walls supported by said collector base and said first and second side tubes, wherein said first and second axes are not parallel to one another.

7. The collector unit as in claim 6, wherein said collector bag is movable between an upright position and a storage position upon rotation of said first and second side tubes.

8. The collector unit as in claim 7, further comprising:
a first strut-linkage having a first end connected to said collector base and a second end connected to said first side tube; and
a second strut-linkage having a first end connected to said collector base and a second end connected to said second side tube, wherein said first and second strut-linkages move in a plane that is parallel to said back end.

9. The collector unit as in claim 8, wherein said first and second axes are not perpendicular to said plane.

10. The collector unit as in claim 8, further comprising a clearance of the fit between said first and second side tubes and said first and second strut-linkage provide sufficient freedom of movement to allow movement between said upright and storage positions.

11. The collector unit as in claim 8, wherein said first and second side tubes and/or said first and second strut-linkage comprise sufficient flexion to provide freedom of movement to allow movement between said upright and storage positions.

12. The collector unit as in claim 6, wherein said first and second axes are not perpendicular to said back end.

13. The collector unit as in claim 6, wherein said first and second axes are angled with respect to said back end by about 100 degrees.

14. The collector unit as in claim 6, wherein said back end is wider than said front end.

15. The collector unit as in claim 6, further comprising a hinge for securing said collector base to a chassis so that said collector base is moveable about said hinge to move between a use position and a dumping position.

16. A collector unit for soil and lawn debris, comprising:
a collector base having a front end, a back end, a first side, and a second side;
a first side tube hingedly secured to said first side for rotation about a first axis;
a second side tube hingedly secured to said second side for rotation about a second axis;
a collector bag having fabric walls supported by said collector base and said first and second side tubes, said collector bag being movable between an upright position and a storage position upon rotation of said first and second side tubes;
a first strut-linkage having a first end connected to said collector base and a second end connected to said first side tube; and
a second strut-linkage having a first end connected to said collector base and a second end connected to said second side tube, said first and second strut-linkages moving in a plane that is parallel to said back end, wherein said first and second axes are not perpendicular to said plane.

17. The collector unit as in claim 16, wherein said first and second axes are angled with respect to said back end by about 100 degrees.

18. The collector unit as in claim 16, wherein said back end is wider than said front end.

19. The collector unit as in claim 16, further comprising a hinge for securing said collector base to a chassis so that said collector base is moveable about said hinge to move between a use position and a dumping position.

20. The collector unit as in claim 16, wherein said first and second axes are not parallel to one another.
